(19) United States
(12) Patent Application Publication
(10) Pub. No.: US 2025/0251681 A1
(43) Pub. Date: Aug. 7, 2025

(54) IMAGE FORMING APPARATUS

(71) Applicant: CANON KABUSHIKI KAISHA, Tokyo (JP)

(72) Inventors: SATOSHI MATSUNO, Kanagawa (JP); KEIZO KOJIMA, Kanagawa (JP)

(21) Appl. No.: 19/041,392

(22) Filed: Jan. 30, 2025

(30) Foreign Application Priority Data
Feb. 2, 2024 (JP) 2024-015296

(51) Int. Cl. G03G 15/20; G03G 15/00; G03G 21/20

(52) U.S. Cl. CPC G03G 15/2014; G03G 15/80; G03G 21/20

(57) ABSTRACT

An image forming apparatus includes an image bearing member, a developing device, a transfer member, a transfer power source and a fixing device. The fixing device is provided with a heating source and a heating member in contact with a recording material in a fixing portion and the heating source heats the recording material through the heating member by heating by the voltage being applied from an AC power source. A detector connected between the image bearing member and a ground potential without interposing the transfer member detects a current or a voltage. A controller controls the current outputting from the transfer power source based on a detecting result of the detecting portion while the toner image is transferred to the recording material from the image bearing member in the transfer portion and the recording material is heated in the fixing portion.

### FIELD OF THE INVENTION AND RELATED ART

The present invention relates to an image forming apparatus such as a printer, a copier, a fax machine, or a multifunctional printer which is equipped with a plurality of functions among those functions by applying an electrophotographic method.

In an image forming apparatus which applies the electrophotographic method, a toner image which is borne on an image bearing member is electrostatically transferred to a recording material such as paper or OHP by applying a transfer voltage to a transfer member which is arranged opposite to an image bearing member such as a drum shaped photosensitive member or a belt shaped intermediary transfer belt. After that, the recording material is conveyed to a fixing device and is heated and pressed at the fixing device, and the toner image is fixed on the recording material. A transfer member forms a transfer nip portion (transfer portion) by contacting an image bearing member, and transfers the toner image from the image bearing member to the recording material which is nipped by the transfer nip portion. The fixing device is provided with a heating member with a heater (heating source) and a pressing member which contacts the heating member and forms a fixing nip portion (fixing portion), and heats the recording material which is nipped by the fixing nip portion. The heating member is heated to a temperature at which it is possible to fix the toner image on the recording material, when the heater generates heat by applying an AC voltage to the heater from a commercial power source.

When the recording material is nipped in the fixing nip portion while the toner image is being transferred, a current which flows from the commercial power source to the heating member, the recording material and the image bearing member may overlap with a transfer current in the transfer nip portion and the transfer current may swing. This phenomenon is also called “AC banding”. As a result, unevenness of transfer property may be occurred and an image defect which is a density unevenness (image unevenness) in a subscanning direction (conveying direction of the recording material) may be occurred in an image which is transferred to the recording material.

Japanese Laid-Open Patent Application No. 2018-97273 discloses an image forming apparatus with a configuration which controls a transfer power source according to a result of comparing a frequency which is obtained from a detected result by a current detecting means which detects a current which flows in the transfer member and a predetermined frequency range which includes a frequency of the commercial power source.

In the configuration which is described in the JP-A 2018-97273, the current which flows to a GND through the heating member, the recording material and the transfer member from the commercial power source is detected and a phase and an amplitude of the transfer power source are switched. In the configuration, the image unevenness may be suppressed under a condition in which an impedance of the transfer member is low.

### SUMMARY OF THE INVENTION

The object which is described above is achieved by the image forming apparatus according to the present invention. In summary, a representative configuration of the present invention is an image forming apparatus comprising: an image bearing member configured to bear a toner image; a developing device configured to supply toner to the image bearing member and form the toner image on the image bearing member; a transfer member configured to form a transfer portion in contact with the image bearing member and to transfer the toner image to a recording material from the image bearing member in the transfer portion; a transfer power source configured to apply a voltage to the transfer member; a fixing device disposed on a downstream side of the transfer portion with respect to a conveyance direction of the recording material and configured to form a fixing portion for nipping the recording material, the fixing device being provided with a heating source for heating the recording material nipped by the fixing portion and a heating member in contact with the recording material in the fixing portion and the heating source heating the recording material through the heating member by heating by the voltage being applied from an AC power source; a detecting portion connected between the image bearing member and a ground potential without interposing the transfer member and configured to detect a current or a voltage; and a control portion configured to control the transfer power source, wherein the control portion controls the current outputting from the transfer power source based on a detecting result of the detecting portion while the toner image is transferred to the recording material from the image bearing member in the transfer portion and the recording material is heated in the fixing portion.

Another representative configuration of the present invention is an image forming apparatus comprising: an image bearing member configured to bear a toner image; a developing device configured to supply toner to the image bearing member and form the toner image on the image bearing member; an intermediary transfer member to which the toner image is transferred from the image bearing member and capable of circularly moving; an opposing member in contact with an inner circumferential surface of the intermediary transfer member; a transfer member in contact with an outer circumferential surface of the intermediary transfer member, configured to form a transfer portion by nipping the intermediary transfer member between itself and the opposing member, and configured to transfer the toner image to a recording material from the intermediary transfer member in the transfer portion; a transfer power source configured to apply a voltage to the transfer member; a fixing device disposed on a downstream side of the transfer portion with respect to a conveyance direction of the recording material and configured to form a fixing portion for nipping the recording material, the fixing device being provided with a heating source for heating the recording material nipped by the fixing portion and a heating member in contact with the recording material in the fixing portion and the heating source heating the recording material through the heating member by heating by the voltage being applied from an AC power source; a detecting portion connected between the opposing member and a ground potential without interposing the transfer member and configured to detect a current or a voltage; and a control portion configured to control the transfer power source, wherein the control portion controls the current outputting from the transfer power source based on a detecting result of the detecting portion while the toner image is transferred to the recording material from the intermediary transfer member in the transfer portion and the recording material is heated in the fixing portion.

Further features of the present invention will become apparent from the following description of exemplary embodiments with reference to the attached drawings.

### BRIEF DESCRIPTION OF THE DRAWINGS

Part (a) of FIG. 1 is a schematic sectional view showing an image forming apparatus according to a first embodiment of the present invention and part (b) of FIG. 1 is a schematic diagram showing a control configuration according to the first embodiment.

FIG. 2 is a graph illustrating an appropriate range of a current when transferring toner to a recording material.

FIG. 3 is a schematic diagram when elements which are related to AC banding are modeled by circuit elements in the image forming apparatus according to the first embodiment.

FIG. 4 is a schematic graph illustrating a current which is detected by a current detecting portion when AC banding occurs.

FIG. 5 is a schematic graph illustrating an occurrence of an image defect due to AC banding.

FIG. 6 is a schematic diagram illustrating the image defect due to AC banding.

Part (a), part (b), part (c) and part (d) of FIG. 7 are schematic graph diagrams illustrating methods how to suppress AC banding.

FIG. 8 is a schematic graph figure illustrating a Gain setting in a control which suppresses AC banding.

FIG. 9 is a flowchart diagram illustrating a procedure for the control which suppresses AC banding.

FIG. 10 is a schematic sectional view showing an image forming apparatus according to a second embodiment.

### DESCRIPTION OF THE EMBODIMENTS

In the following, an image forming apparatus according to the present invention will be specifically described in accordance with figures. However, size, material, shape and their relative positioning, etc. of component parts which are described in embodiments below may be changed as appropriate depending on a configuration of an apparatus to which the present invention is applied and various conditions. That is, a scope of the present invention is not limited to the embodiments below.

### First Embodiment

### <Configuration of the Image Forming Apparatus>

A schematic configuration of an image forming apparatus 1 according to the embodiment will be described by using part (a) and part (b) of FIG. 1. Part (a) of FIG. 1 is a schematic sectional view showing the image forming apparatus 1 according to the embodiment, and part (b) of FIG. 1 is a schematic diagram showing a control configuration of the image forming apparatus 1 according to the embodiment. The image forming apparatus 1 according to the embodiment is a laser beam printer which is able to form a monochrome black image on a sheet shaped recording material R by using an electrophotographic method.

A photosensitive drum 11, which is a drum shaped photosensitive member (electrophotographic photosensitive member) as an image bearing member, is rotationally driven at a predetermined peripheral speed (process speed) in a direction of an arrow D (clockwise direction) in the figure by a drum driving motor (unshown in figures) as a driving means. A surface of the photosensitive drum 11 (outer peripheral surface) which is rotating is uniformly charged to a predetermined potential of a predetermined polarity (negative polarity in the embodiment) by a charging roller 12 which is a roller type charging member as a charging means. The charging roller 12 is arranged to contact the surface of the photosensitive drum 11, and is rotated by a rotation of the photosensitive drum 11. During charging process, a charging voltage (charging bias) is applied to the charging roller 12 by a charging power source (unshown in the figures) as a charging voltage application means. The surface of the photosensitive drum 11 which is charged is scanned and exposed by a scanner unit (exposure device) 14 as an exposure means (light irradiation means), and an electrostatic latent image (electrostatic image) is formed on the photosensitive drum 11. The scanner unit 14 irradiates the surface of the photosensitive drum 11 with laser light according to an image signal and the electrostatic latent image is formed on the photosensitive drum 11. The electrostatic latent image which is formed on the photosensitive drum 11 is developed (visualized) by a developing device 15 as a developing means, which supplies toner as developer, and a toner image (toner picture image, developer image) is formed on the photosensitive drum 11. The developing device 15 includes a developing sleeve 15a as a developing member (developer carrying member) and a developer container 15b which accommodates toner. The developing sleeve 15a carries the toner in the developer container 15b to the part opposite the photosensitive drum 11 (developing portion), and attaches the toner to the electrostatic latent image on the photosensitive drum 11 to form a toner image. During development, a developing voltage (developing bias) is applied to the developing sleeve 15a by a developing power source (unshown in the figures) as a developing voltage application means. In the embodiment, toner which is charged with the same polarity as a charged polarity of the photosensitive drum 11 (negative polarity in the embodiment) adheres to an exposed area (image portion) on the photosensitive drum 11 in which absolute value of potential is decreased by being exposed after it is uniformly charged (reversal development method). In the embodiment, a normal polarity of the toner, which is a main charged polarity of the toner during development, is negative.

A transfer roller 17, which is a roller type transfer member as a transfer means, is arranged in a position which is opposed to the photosensitive drum 11. The transfer roller 17 contacts the surface of the photosensitive drum 11 and forms a transfer nip portion (transfer portion) Nt which is a contact portion between the photosensitive drum 11 and the transfer roller 17. The toner image which is formed on the photosensitive drum 11 is transferred to the recording material R which is nipped and conveyed between the photosensitive drum 11 and the transfer roller 17 in a transfer nip portion Nt. During transferring, a transfer voltage (transfer bias), which is a direct current voltage (DC voltage) with a polarity which is opposite to the normal charged polarity of the toner (positive polarity in the embodiment), is applied to the transfer roller 17 by a transfer power source 18 as a transfer voltage application means. The recording material (transfer material, recording media, sheet) such as paper and OHP is accommodated in a cassette 5 as a recording material accommodating portion. A pickup roller 6 as a feeding member sends out the recording material R from the cassette 5 to a conveying passage for the recording material R. A conveying roller pair 7 and 8 as a conveying member adjusts timing for conveying the recording material R which is sent out by the pickup roller 6 to the transfer nip portion Nt. And in the transfer nip portion Nt, the toner image is transferred to the recording material R which is conveyed by the conveying roller pair 7 and 8 from the photosensitive drum 11. The photosensitive drum 11 is connected (electrically grounded) to the GND (ground potential) when its core metal portion is electrically connected to a sheet metal portion (unshown in the figures) such as a frame of the image forming apparatus 1. And in the embodiment, a current detecting portion (current detection circuit) 13 as a current detection means is provided between the core metal portion of the photosensitive drum 11 and the GND. The current detecting portion 13 is connected between the photosensitive drum 11 and the GND without interposing the transfer roller 17. That is, the current detecting portion 13 is connected between the photosensitive drum 11 and the GND in a current path from the transfer power source 18 through the transfer roller 17 and the photosensitive drum 11 to the GND.

The recording material R, to which the toner image is transferred, is conveyed to a fixing device 20 as a fixing means after a static charge which is accumulated on a surface of the recording material R is removed by a neutralizing member 19. The toner which remains on the surface of the photosensitive drum 11 after the toner image is transferred to the recording material R (transfer residual toner) is removed (cleaned) from the surface of the photosensitive drum 11 by the cleaning device 16 as a cleaning means and collected. The cleaning device 16 includes a cleaning blade 16a as a cleaning member which is arranged to contact the surface of the photosensitive drum 11, and a cleaning container 16b. The cleaning device 16 scrapes off the transfer residual toner from the surface of the rotating photosensitive drum 11 by the cleaning blade 16a and store it in the cleaning container 16b.

The fixing device 20 includes a heating member 21 with which a heat source is provided, and a pressing roller 24 as a pressing member which contacts the heating member 21 and forms a fixing nip portion (fixing portion) Nf. The heating member 21 is configured to include a fixing film 22 which is a first fixing member (first fixing rotatable member), a heater 23 which is a heat source which contacts the pressing roller 24 which is a second fixing member (second fixing rotatable member) via the fixing film 22. A heating nip member is configured of the fixing film 22 which is the first fixing member, and the pressing roller 24 which is the second fixing member. The heating member 21 is heated to a temperature at which it is possible to fix the toner image on the recording material R, when the heater 23 generates heat by applying an alternating current voltage (AC voltage) from a commercial power source (AC power source) 30 to the heater 23. Further, the pressing roller 24 is connected to the GND (electrically grounded) via an electronic part 25 from a perspective of safety in a case that a user contacts it and fracture strength in a case that lightning surge is applied from the commercial power source 30. The fixing nip portion Nf, which is a contact portion between the fixing film 22 and the pressing roller 24, is formed, when the pressing roller 24 is pressed against the heater 23 via the fixing film 22. The pressing roller 24 is rotationally driven by a fixing driving motor (unshown in the figures) as a driving means in a direction of an arrow F (counterclockwise direction) in the figure. The fixing film 22 is rotationally driven by a rotation of the pressing roller 24, while sliding with the heater 23. As for the heater 23, any available configuration such as a publicly known device, for example, may be used. For example, the heater 23 includes a board, an electrode portion to which voltage from an AC power source is applied and a heat generating resistor which is formed on a surface of the board. The heat generating resistor generates heat when a current flows through the electrode portion by applying a voltage to the electrode portion from the AC power source. When heat is generated by the heat generating resistor, the heater 23 is possible to heat the recording material R which is nipped by the fixing nip portion Nf. The fixing device 20 heats and presses the recording material R on which a toner image is transferred by nipping and conveying between the fixing film 22 and the pressing roller 24 at the fixing nip portion Nf, and the toner image is fixed (melted, adhered) on the recording material R.

After the toner image is fixed by the fixing device 20, the recording material R is discharged (output) to a discharging tray 3 as a discharging portion which is provided on an outside (top surface) of a main assembly of the image forming apparatus 1 (hereafter simply referred to as a main assembly) 2.

In the embodiment, the photosensitive drum 11, the charging roller 12 as a process means which acts on the photosensitive drum, the developing device 15 and the cleaning device 16 are configured as a process cartridge 4 which is integrally dismountable from the main assembly 2. The process cartridge 4 is replaced with a new one, for example, in a case that an amount of the toner which is accommodated in the developer container 15b of the developing device 15 becomes less than a predetermined amount, a case that the photosensitive drum 11 reaches an end of lifetime or a case that the developing sleeve 15a reaches an end of lifetime, etc. Incidentally, in the embodiment, the main assembly 2 is the image forming apparatus 1 in a part except the process cartridge 4.

An environmental sensor 9 is provided with the image forming apparatus 1. In the embodiment, the environmental sensor 9 is capable of detecting temperature and humidity of a surrounding environment of the image forming apparatus 1. Incidentally, the environmental sensor 9 is one of examples of an environmental detection means (environmental detecting portion) which detects environmental information, which is at least one of temperature or humidity at least one of inside or outside of the image forming apparatus 1.

Further, the image forming apparatus 1 is provided with a control portion (control circuit) 10 as a control means. The control portion 10 is configured to include a CPU 10a which is a calculation control portion, a memory portion 10b and a transfer power source control portion 10c. The memory portion 10b is configured with a ROM, a RAM, a nonvolatile memory, etc. A print start instruction and an image signal is sent to the control portion 10 from an external device (unshown in the figures) such as a personal computer. The image forming apparatus 1 executes image forming when the control portion 10 controls each portion of the image forming apparatus 1 based on the print start instruction and the image signal which are input. The memory portion 10b stores programs and data which are related to image forming, and the CPU 10a controls each portion of the image forming apparatus 1 according to the programs and the data.

Detection information (detection signal) which is obtained by the current detecting portion 13 and detection information which is obtained by the environmental sensor 9 are input to the control portion 10, respectively. The current detection information which is input from the current detecting portion 13 to the control portion 10 is converted to a digital value by an analog/digital (A/D) conversion portion of the CPU 10a. The CPU 10a obtains current detection information which is A/D converted at a predetermined interval. Humidity and temperature information which is input from the environmental sensor 9 to the control portion 10 is also converted to the digital value by an A/D conversion portion of the CPU 10a, and is obtained by the CPU 10a, in the same way as the current detection information. Further, in the embodiment, the memory portion 10b stores a cumulative number of sheets which are printed by using the photosensitive drum 11 as a cumulative amount of use information of the photosensitive drum 11 which is replaceable. Further, in the embodiment, the memory portion 10b stores the cumulative number of sheets which are printed by using the transfer roller 17 (the main assembly 2) as a cumulative amount of use information of the transfer roller 17 (main assembly 2). Incidentally, the cumulative number of sheets which are printed is one of examples of an index value (a value which is related to the cumulative amount of use information) which correlates with an amount of use of the image forming apparatus 1 and an element of the image forming apparatus 1. Further, the cumulative number of sheets which are printed may be added up by counting a case that an image is formed on one side of the recording material R which is a predetermined size as one sheet, for example. Further, the cumulative number of sheets which are printed of the photosensitive drum 11 is reset to an initial value (zero in the embodiment) in a case that the photosensitive drum 11 is replaced together with the charging roller 12, the developing device 15, etc. The CPU 10a uses the current detection information, the humidity and temperature information and information of the cumulative number of sheets which are printed, and outputs a signal which is necessary for controlling the transfer power source 18 to the transfer power source control portion 10c. The details of this are explained later.

Incidentally, since paper is mainly used as the recording material R for the image forming apparatus 1, the recording material R is sometimes referred to as paper, however, the recording material R is not limited to paper. As for the recording material R, for example, material which is configured of material which is other than paper or material which includes material other than paper, such as synthetic paper or film which is configured mainly of synthetic resin, or special paper such as metallized paper which includes a metal layer, may also be used.

Further, the index value (value which is related to cumulative amount of use information) which correlates with the amount of use of the image forming device 1 or the element of the image forming device 1 is not limited to the cumulative number of sheets which are printed. For example, it may be a value which is related to an amount of consumed toner or an amount of remaining toner in the developing device 15. Further, for example, it may be the number of rotations of the photosensitive drum 11 or the rotation time of the photosensitive drum 11, the number of rotations during the charging process of the photosensitive drum 11 or the rotation time during the charging process of the photosensitive drum 11, etc.

### <Mechanism of Transfer>

Next, a mechanism, how the toner is transferred from the photosensitive drum 11 to the recording material R, will be described.

When the recording material R is nipped between the photosensitive drum 11 and the transfer roller 17 while the toner is on the photosensitive drum 11, a voltage of an opposite polarity to the toner is applied from a side of the recording material R which is opposite to a side on which the toner is transferred. In this way, a current is flown between the photosensitive drum 11 and the recording material R, and the toner is transferred to the recording material R. At this time, since the current which flows through the transfer nip portion Nt changes depending on a value of resistance (electric resistance, hereinafter the same applies) of the recording material R, it may cause an image defects when it is not appropriately set.

### <Setting Method of Transfer Current and Transfer Voltage>

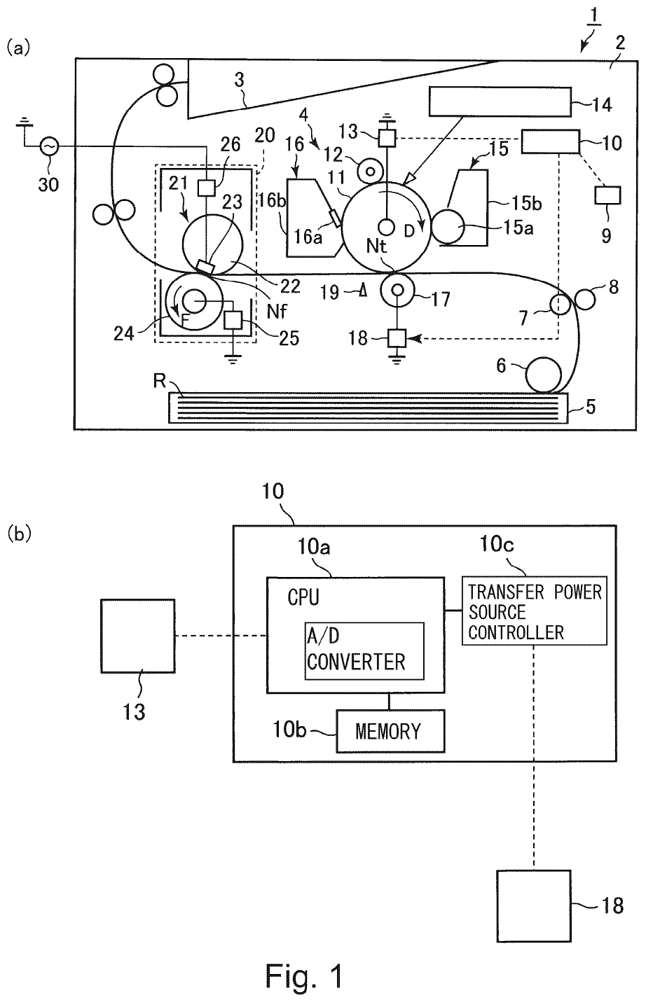

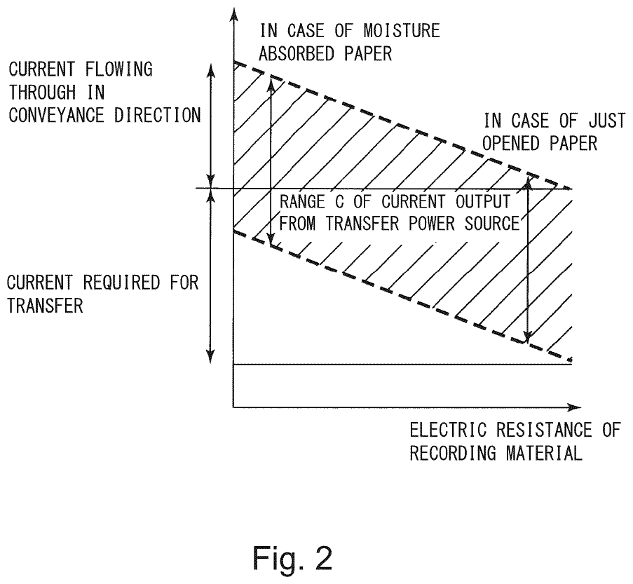

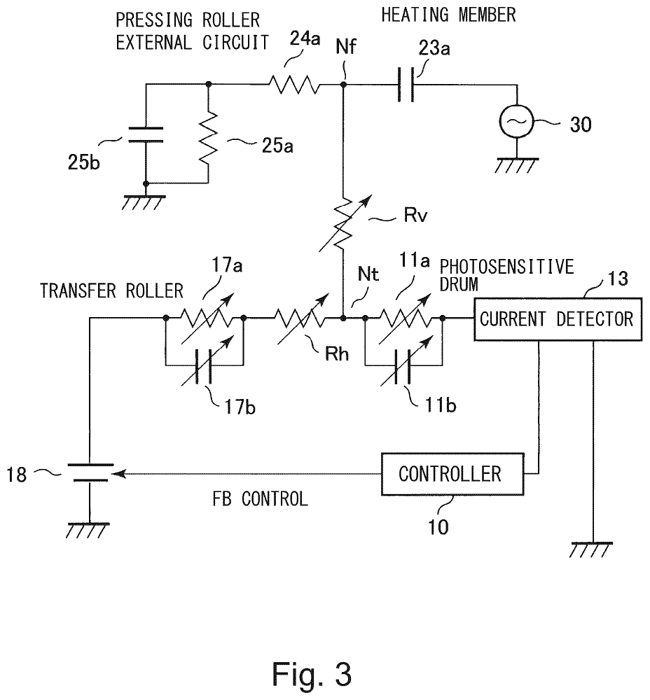

Next, a setting method of a transfer voltage according to the embodiment will be described by using FIG. 2 and FIG. 3. FIG. 2 is a graph showing a relationship between a resistance value of the recording material R and a current which is output by the transfer power source 18. The figure shows that an appropriate range of the current which flows from the transfer roller 17 to the recording material R, when transferring the toner image from the photosensitive drum 11 to the recording material R, differs depending on the resistance value of the recording material R. Further, FIG. 3 is a schematic diagram which models elements around the transfer nip portion Nt and the fixing nip portion Nf according to the embodiment of the image forming apparatus 1 by using circuit elements.

In FIG. 3, a capacity (electric capacity, hereinafter the same applies) component of the heating member 21 of the fixing device 20 which is mainly a capacity component of the heater 23 in the embodiment is defined as a capacity 23a, a resistance component of the pressing roller 24 is defined as a resistance 24a, a ground resistance between the pressing roller 24 and the GND is defined as a resistance 25a, and a ground capacity is defined as a capacity 25b. Further, in FIG. 3, a resistance component of the transfer roller 17 is defined as a resistance 17a, a capacity component of the transfer roller 17 is defined as a capacity 17b, a resistance component of the photosensitive drum 11 is defined as a resistance 11a, and a capacity component of the photosensitive drum 11 is defined as a capacity 11b. Further, in FIG. 3, a resistance Rv represents a resistance value in a conveying direction of the recording material R, and a resistance Rh represents a resistance value in a thickness direction of the recording material R. Further, as described above, the image forming apparatus 1 is provided with the current detecting portion 13, and detected results by the current detecting portion 13 are input to the control portion 10. And an output voltage of the transfer power source 18 is controlled by the transfer power source control portion 10c of the control portion 10, according to a calculated result by the CPU 10a of the control portion 10.

Incidentally, the current detecting portion 13 may be configured to detect the current which flows to the GND via the transfer power source 18, the transfer roller 17, the recording material R and the photosensitive drum 11, and variation of the current which flows to the GND via the heating member 21 (the heater 23), the recording material R and the photosensitive drum 11 (more specifically, a current in which the current which flows to the GND via the transfer power source 18, the transfer roller 17, the recording material R and the photosensitive drum 11, and the current which flows to the GND via the heating member 21 (the heater 23), the recording material R and the photosensitive drum 11, are superimposed). Specifically, for example, a high pass filter (HPF) circuit, which applies a coupling capacitor and an operational amplifier, etc. may be used.

Here, the resistance values and the capacity values of the recording material R and the transfer roller 17 change depending on the environment, and in general, the resistance value decreases in a high temperature and high humidity environment. Further, since the photosensitive drum 11 also contacts the transfer roller 17 and the recording material R, the resistance value and the capacity value change due to wear, etc. in accordance with an increase in the cumulative number of sheets which are printed. For example, as the number of sheets which are printed increases, the capacity value of the photosensitive drum 11 increases. Furthermore, the resistance value and the capacity value of the transfer roller 17 also change due to contamination and uneven distribution of conductive agent as the cumulative number of sheets which are printed increases. For example, as the cumulative number of sheets which are printed increases, the resistance value of the transfer roller 17 increases.

In the following, it will be described as the recording material R, whose electric resistance is lowered due to absorbing moisture, is defined as “moisture absorbed paper”, and the recording material R, whose electric resistance is not lowered since it is just after opening wrapping paper and moisture is not absorbed, is defined as “just opened paper”. As shown in FIG. 2, an appropriate range of a value of the current which flows from the transfer roller 17 to the recording material R differs depending on the surrounding environment. The current which flows from the transfer roller 17 is injected to the recording material R and flows toward the photosensitive drum 11. Here, since the electric resistance of the moisture absorbed paper is lower than the just opened paper, the current which is injected from the transfer power source 18 via the resistance 17a to the resistance Rh in FIG. 3 flows more the resistance RV. That is, the current which is injected from the transfer roller 17 to the recording material R flows via the moisture absorbed paper, for example, to a ground resistance 25a or a ground capacity 25b between the pressing roller 24 and the GND, and the current which flows from the recording material R toward the photosensitive drum 11 may be in shortage. Therefore, it is necessary to apply a higher voltage from the transfer power source 18 to the transfer roller 17, since it is necessary to apply more current from the transfer roller 17 toward the moisture absorbed paper. On the other hand, since the electric resistance of the just opened paper is higher than the moisture absorbed paper, the current which flows from the transfer power source 18 via the resistance 17a and the resistance Rh to the resistance Rv is reduced. Therefore, it is possible to set the voltage which is applied to the transfer roller 17 from the transfer power source 18 lower than a case of the moisture absorbed paper.

In a case that, the output voltage of the transfer power source 18 is set for the just opened paper to the same high voltage as for the moisture absorbed paper, since the current which is injected from the transfer roller 17 to the recording material R and flows to the photosensitive drum 11 becomes excessive, the polarity of the toner in the transfer nip portion Nt may be reversed, and the toner may be transferred from the just opened paper to the photosensitive drum 11 on the contrary. Therefore, as shown in FIG. 2, it is preferable that the value of the current which is injected from the transfer roller 17 to the recording material R is within an appropriate range C (shaded area). In the embodiment, the CPU 10a of the control portion 10 sets a target current so that the current within the appropriate range C flows to the transfer nip portion Nt, using the detected result by the environmental sensor 9 and the cumulative amount of use information (in the embodiment, the cumulative number of sheets which are printed of the photosensitive drum 11 and the cumulative number of sheets which are printed of the transfer roller 17) which is stored in the memory portion 10b. And the transfer power source control portion 10c of the control portion 10 performs constant current control of transfer voltage which is applied from the transfer power source 18 to the transfer roller 17 so that the current of the target current flows to the transfer nip portion Nt.

<Mechanism of Image Defect which is Caused by AC Banding>

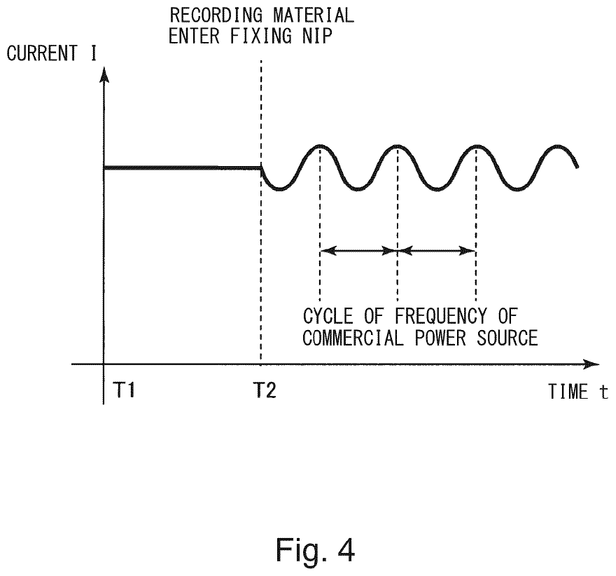

Next, a mechanism how an image defect is caused by AC banding will be described by using from FIG. 4 through FIG. 6.

FIG. 4 is a schematic graph to illustrate the current which flows to the transfer nip portion Nt during printing. In FIG. 4, time T1 is a time when the recording material R enters the transfer nip portion Nt, and time T2 is a time when the recording material R enters the fixing nip portion Nf. From the time T1 to a time before time T2, the recording material R is not nipped at the fixing nip portion Nf, and an AC current from the commercial power source 30 is not superimposed on the transfer current, so the current which flows to the transfer nip portion Nt becomes a constant current. On the other hand, after the time T2 when the recording material R is nipped at both of the transfer nip portion Nt and the fixing nip portion Nf, the AC current of the commercial power source 30 is superimposed on the transfer current via the recording material R. As a result, the current which flows to the transfer nip portion Nt swings with a frequency cycle of the commercial power source 30 and the AC banding is caused.

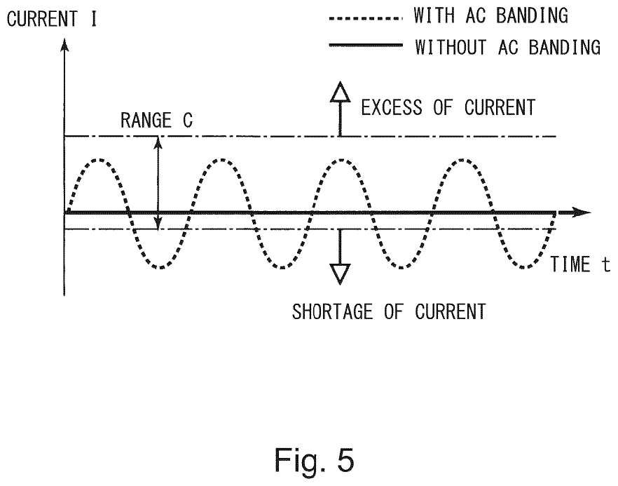

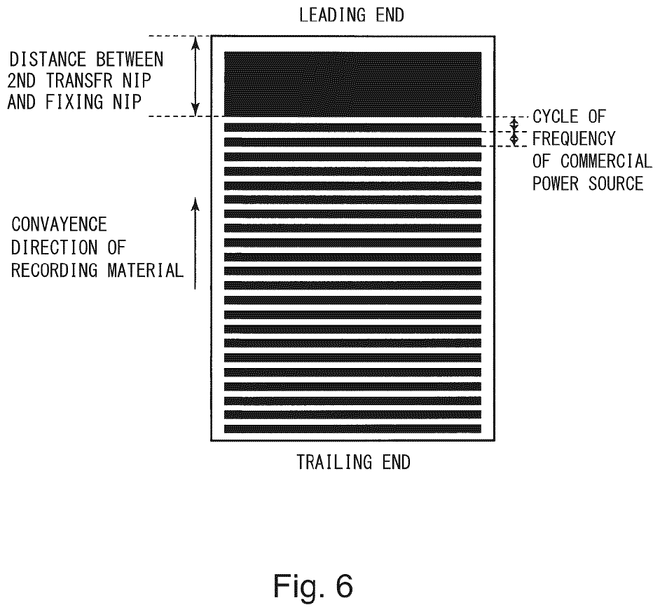

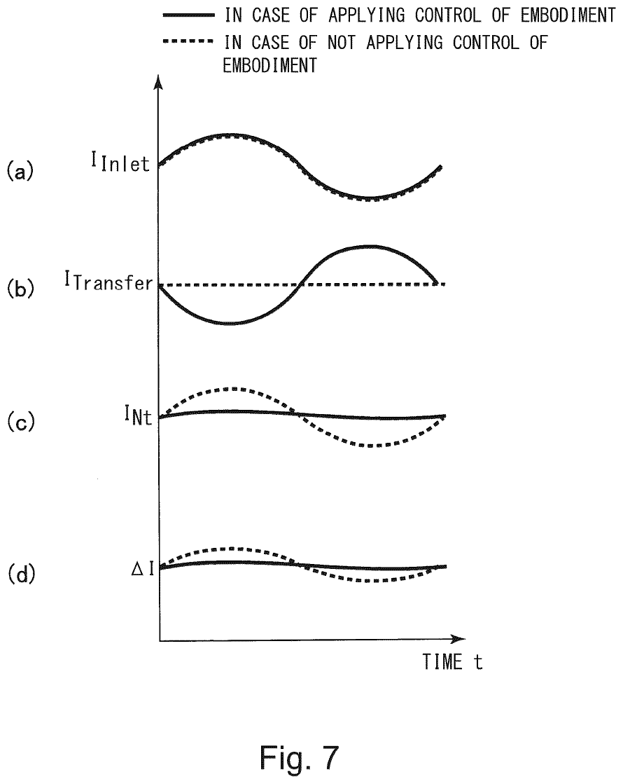

FIG. 5 is a schematic graph to illustrate an occurrence of an image defect caused by the AC banding. Further, FIG. 6 is a schematic diagram of an image in which the image defect is caused by the AC banding. As described above, the control portion 10 considers the humidity and temperature information which is obtained by the environmental sensor 9, etc., and adjusts the transfer voltage which is applied from the transfer power source 18 to the transfer roller 17 so that the current which flows to the transfer nip portion Nt is kept within the appropriate range C, as shown by a solid line in FIG. 5. However, after the time T2, the current which flows from the recording material R to the photosensitive drum 11 may exceed the appropriate range C due to an addition of the AC current from the commercial power source 30. For example, in a case that a waveform is as shown by a broken line in FIG. 5, since the current which flows to the transfer nip portion Nt swings with the cycle of the frequency of the commercial power source 30, a valley part of the waveform becomes below the appropriate range C of the current when transferring the toner image. As a result, the current is in shortage for the cycle of the frequency of the commercial power source 30, and as shown in FIG. 6, after the recording material R enters the fixing nip portion Nf, density unevenness (image unevenness) in the cycle of the frequency of the commercial power source 30 may be caused for the image which is transferred from the photosensitive drum 11 to the recording material R.

<Method for Suppressing an Image Defect which is Caused by the AC Banding>

Next, a method how to suppress an image defect which is caused by the AC banding in the embodiment will be described by using from FIG. 7 through FIG. 9.

Waveforms, when the AC banding occurs, are schematically shown in all from part (a) through part (d) of FIG. 7, and the waveforms in a case that a control according to the embodiment is applied are indicated by solid lines and the waveforms in a case that a control according to the embodiment is not applied are indicated by dashed lines. Part (a) of FIG. 7 shows the waveform of a current “I_{Inlet}” which flows from the commercial power source 30 to the transfer nip portion Nt, part (b) of FIG. 7 shows the waveform of an output current “I_{Transfer}” of the transfer power source 18, part (c) of FIG. 7 shows the waveform of a current “I_{Nt}” in the transfer nip portion, and part (d) of FIG. 7 shows the waveform of a current amplitude “ΔI” which is detected by the current detecting portion 13.

The current in the transfer nip portion Nt (I_{Nt}) is a superposition of the current which is a part of the current from the commercial power source 30 and flows to the transfer nip portion Nt (I_{Inlet}) and a part of the output current (I_{Transfer}) of the transfer power source 18. In a case that the control in the embodiment is not applied, as shown by the dashed line in part (c) of FIG. 7, an AC current (alternating current) from the commercial power source 30 is superimposed on a DC current (direct current) from the transfer power source 18, and the current (I_{Nt}) at the transfer nip portion Nt swings. As described by using FIG. 5, in a case that the current amplitude is large and exceeds the appropriate range C, the image unevenness which is caused by the AC banding may be occurred.

Therefore, in the embodiment, the output current (I_{Transfer}) of the transfer power source 18 is controlled based on the current amplitude (ΔI) which is shown by the dashed line in part (d) of FIG. 7, as shown by the solid line in part (b) of FIG. 7 (details will be described below). As a result, since the current amplitude (ΔI) of the current detecting portion 13 decreases as shown by the solid line in part (d) of FIG. 7, it is also possible to suppress a fluctuation of the current (I_{Nt}) of the transfer nip portion Nt as shown by the solid line in part (c) of FIG. 7.

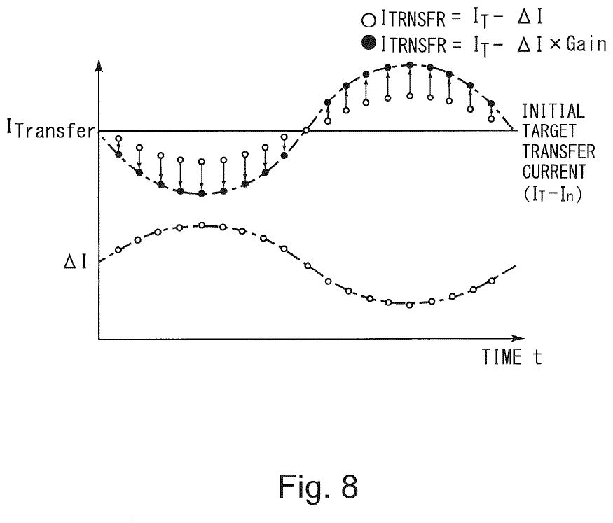

FIG. 8 is a schematic graph showing one of examples of the current amplitude (ΔI) of the current detecting portion 13 and the output current (I_{transfer}) of the transfer power source 18 when the AC banding occurs.

As shown in FIG. 8, when the output current of the transfer power source 18, which does not suppress the AC banding, is the same solid line as an initial transfer target current (I_{S}), detection results of the current amplitude (ΔI) of the current detecting portion 13 is shown as white circles and a dotted line. In principle, it is possible to suppress the AC banding by newly setting a difference between the white circles and the dotted line of the current amplitude (ΔI) and the solid line of the initial transfer target current (I_{S}) as a final transfer current target value (I_{T}) which reflects the suppression of the AC banding.

However, in fact, it is preferable to determine a correction amount for the transfer current target value (I_{T}) of the output current (T_{ransfer}) of the transfer power source 18 by using following three parameters.
I. A change in the current amplitude due to an impedance of a resistance component 17a and a capacity component 17b of the transfer roller 17, a resistance Rh of the recording material R and a resistance component 11a and a capacity component 11b of the photosensitive drum 11.
II. A current phase delay due to the capacity component 17b of the transfer roller 17 and the capacity component 11b of the photosensitive drum 11.
III. A response delay of a circuit from an output of the transfer power source 18 to the transfer nip portion Nt.

The target value of the transfer current is corrected by multiplying the current amplitude (ΔI) which is obtained by the current detecting portion 13 by the Gain determined by these parameters. Here, gain can be expressed by the following formula 1.

$$Gain = {Gain}_{Ref} \times Env \times K \qquad ( Formula 1 )$$

(Gain_{Ref}: Gain in normal temperature and humidity environment, Env: Environmental coefficient, K: Cumulative amount of use coefficient)

Gain_{Ref} is a correction gain as a reference, and is determined in advance based on factors such as a circuit response delay and a circuit gain of the transfer power source 18 and representative temperature and humidity (for example, 23° C., 50% RH).

Env is a coefficient which represents an impedance change of the transfer roller 17, the recording material R, the photosensitive drum 11, etc. (at least one of them) due to the environment, and is determined based on the humidity and temperature information (furthermore, information on a variety of the recording material R) which is obtained by the environmental sensor 9. Incidentally, in the embodiment, Env is determined based on the impedance which is selected from a table showing a relationship between the humidity temperature information and the impedance of the transfer roller 17, the recording material R, the photosensitive drum 11, etc. (at least one of them) which is calculated in advance and stored in the memory portion 10b in advance. However, a method of determining Env is not limited to this. For example, Env may be determined based on the impedance which is calculated based on information such as the voltage of the transfer power source 18, the humidity and temperature information and the rate of change in the impedance of the transfer roller 17, the recording material R, the photosensitive drum 11, etc. (at least one of them) due to the voltage of the transfer power source 18 and the humidity and temperature information. Further, for example, Env may be selected from a table showing the relationship between the environmental information which is calculated in advance and stored in the memory portion 10b and Env in which the change of the impedance is reflected. Incidentally, in the embodiment, the information about the variety of the recording material R is input to the control portion 10 from the external device together with the print start instruction, the image signal and print settings. Here, the variety of the recording material R includes any information which is possible to distinguish the recording material R, such as attributes based on general characteristics (as it is called paper type category), such as plain paper, coated paper, cardboard and synthetic paper, numerical values and numerical ranges such as basis weight and thickness, and brand names (including manufacturers and product numbers).

K is a coefficient in a case that the phase delay of the current is occurred due to changes in the capacity component 17b of the transfer roller 17 or the capacity component 11b of the photosensitive drum 11 (at least one of them) by increase in the cumulative amount of use of the main assembly 2 or toner consumption. K is determined based on the cumulative number of the sheets which is printed which is stored in the memory portion 10b (at least one of information of the cumulative number of the sheets which is printed for the photosensitive drum 11 and information of the cumulative number of the sheets which is printed for the transfer roller 17). In the embodiment, K is determined based on a rate of a change in a capacity component which is selected from a table which shows a relationship between the cumulative number of the sheets which is printed which is calculated in advance and stored in the memory portion 10b in advance (at least one of the information of the cumulative number of the sheets which is printed for the photosensitive drum 11 which is replaceable and the information of the cumulative number of the sheets which is printed for the transfer roller 17 (the main assembly 2)) and a rate of a change in the capacity component of the photosensitive drum 11 and the capacity component of the transfer roller 17 (at least one of them) for each cumulative number of sheets which is printed (that is in accordance with an increase in the cumulative number of the sheets which are printed). However, a method of determining K is not limited to this. For example, K is determined based on a rate of a change in a capacity component which is calculated based on information such as the cumulative amount of use information (at least one of the cumulative amount of use information of the photosensitive drum 11 and the cumulative amount of use information of the transfer roller 17 (the main assembly 2)) and a rate of a change in the capacity component of the photosensitive drum 11 and the capacity component of the transfer roller 17 (at least one of them) due to the cumulative amount of use information. Further, K may be selected from a table which shows a relationship between the cumulative usage information which is calculated in advance and stored in the memory portion 10b and K in which the changes in the capacity components which are described above are reflected.

By multiplying Gain which is determined as described above by the current amplitude (ΔI) of the current detecting portion 13, the output current (I_{Transfer}) of the transfer power source 18 becomes a waveform which is like that the phase of the current amplitude (ΔI) is reversed as shown by the black circles and the dashed line in FIG. 8.

In this way, in the embodiment, the control portion 10 switches the voltage which is applied from the transfer power source 18 to the transfer roller 17 to match a phase of a power source frequency of the commercial power source 30. That is, in a time which corresponds to the valley part of the waveform of the current amplitude (ΔI), the voltage which is applied to the transfer roller 17 from the transfer power source 18 is greater than the voltage which is applied to the transfer roller 17 when control to suppress the AC banding is not performed. Further, in a time which corresponds to a peak part of the waveform of the current amplitude (ΔI), the voltage which is applied to the transfer roller 17 from the transfer power source 18 is smaller than the voltage which is applied to the transfer roller 17 when the control to suppress the AC banding is not performed. As a result, the voltage which is applied from the transfer power source 18 to the transfer roller 17 is periodically controlled to match the phase of the power source frequency of the commercial power source 30, and as shown by the solid line in part (c) of FIG. 7, it is possible to suppress the fluctuation of the current in the transfer nip portion Nt.

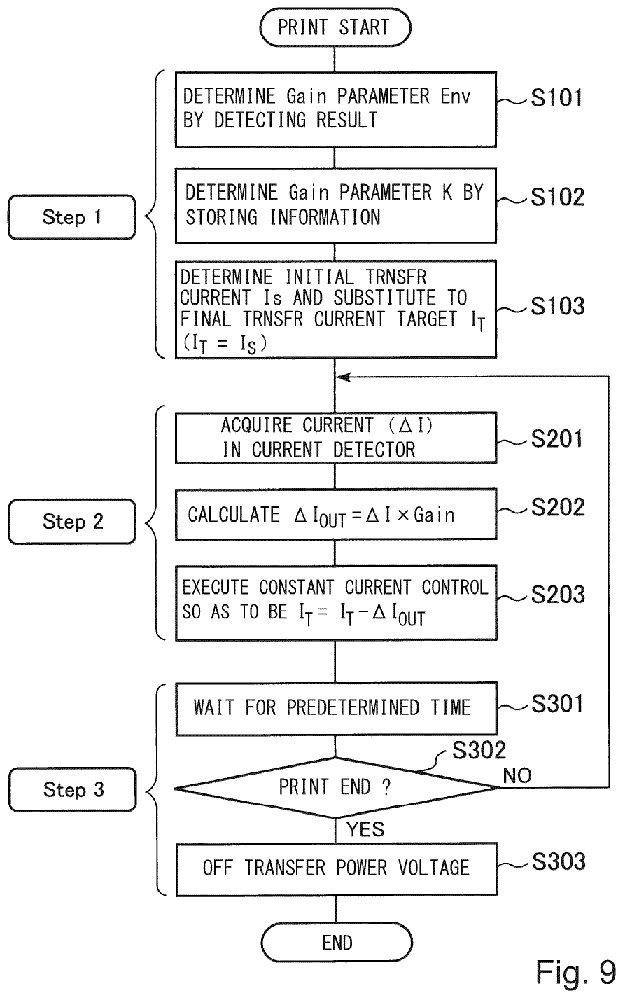

FIG. 9 is a flowchart diagram of a control which detects the current amplitude (ΔI) at the current detecting portion 13 and suppresses the AC banding in the example.

### <Step 1>

In the step, a parameter which is necessary for performing the constant current control of the transfer power source 18 is determined. First, the CPU 10a acquires the environmental information which is obtained by the environmental sensor 9 which is converted to a digital value by the A/D conversion portion at a time of start of printing, and determines an environmental coefficient Env based on a table showing a relationship between the humidity and temperature information and impedance which is stored in the memory portion 10b in advance (S101). After that, similarly, the CPU 10a determines a cumulative usage coefficient K based on a table showing a relationship between the information of the cumulative number of the sheets which is printed for the replaceable photosensitive drum 11 which is stored in the memory portion 10b, the information of the cumulative number of the sheets which is printed for the transfer roller 17, and a capacity component change rate for each of those number of the sheets which is printed (S102). Next, the CPU 10a determines an initial transfer current target value (I_{S}) which is a standard based on the variety of the recording material R, the print setting information, etc., and substitutes it for the final transfer current target value (I_{T}) (S103).

### <Step 2>

In this step, the final transfer current target value (I_{T}) is calculated, considering the suppression of the AC banding. The CPU 10a acquires the current amplitude (ΔI) which is detected by the current detecting portion 13 and converted to digital by the A/D conversion portion (S201). Next, the CPU 10a calculates an AC banding correction value (ΔIₒᵤₜ) based on the acquired current amplitude (ΔI) and the Gain which is calculated in the Step 1 (S202). And the CPU 10a calculates a difference between the final transfer current target value (I_{T}) and the AC banding correction value (ΔIₒᵤₜ), and outputs a signal which is necessary to control the transfer power source 18 from the transfer power source control portion 10c so that the output current (I_{Transfer}) of the transfer power source 18 becomes the final transfer current target value (I_{T}) (S203).

Here, the transfer power source 18 and the transfer power source control portion 10c according to the embodiment will be described in brief. The transfer power source 18 according to the embodiment is a power source circuit which applies a flyback transformer, and it controls the current to become a desired current while flowing intermittently the current which flows through a primary side coil of the flyback transformer by a switching means. At this time, the intermittent current is sent to the primary side coil of the flyback transformer by sending a PWM signal from the transfer power source control portion 10c to the switching means. The transfer power source 18 is provided with a constant current detection circuit portion (unshown in the figures) which detects the output current (I_{Transfer}). And the CPU 10a adjusts a Duty of the PWM signal which is sent from the transfer power source control portion 10c to the transfer power source 18 so that the output current (I_{Transfer}), which is detected by the constant current detection circuit portion which is input to the CPU 10a separately from the detected result by the current detecting portion 13, becomes the transfer current target value (I_{T}). In the embodiment, an example which applies the flyback transformer is introduced, however, it is not limited to this. It is sufficient that the transfer power source 18 can be controlled so that the output current (I_{Transfer}) of the transfer power source 18 becomes the final transfer current target value (I_{T}).

### <Step 3>

In this step, it determines whether the process is returned or terminated depending on whether printing is finished or not. The CPU 10a continues (waiting for updating of setting) to set the transfer current target value (I_{T}) and apply the transfer voltage as done in the Step 2 for a predetermined period of time (S301). And the CPU 10a determines whether or not printing (all of jobs) is finished (S302). Incidentally, the jobs are a series of operations which form an image on single or the plurality of recording materials R and output it from the image forming apparatus 1, starting with a single start instruction. And in a case that printing is not finished, the CPU 10a returns to the Step 2, updates the final transfer current target value (I_{T}) and changes the output of the transfer power source 18. The CPU 10a repeats from the Steps 2 to the Step 3 until printing is finished. On the other hand, in a case that printing is finished, the CPU 10a turns off the transfer power source 18 and finish the operations of the image forming apparatus 1 (S303).

The loop from the Step 2 to the Step 3 is performed at a predetermined interval. Here, the predetermined interval may be an interval in which it is possible to suppress the AC banding. It is preferable that the predetermined interval is a time which is sufficiently shorter than a cycle of the AC voltage of the commercial power source which is a frequency of 50 Hz (cycle of 20 ms) or 60 Hz (approximately 16.7 ms), such as 1 ms. For example, it is possible that the predetermined interval is set to a time of 0.5 ms or more, 15 ms or less, or preferably 1 ms or more, 10 ms or less.

As described above, in the embodiment, the image forming apparatus 1 is provided with the image bearing member (photosensitive drum) 11 which bears the toner image, the developing device 15 which supplies the toner to the image bearing member 11 and forms the toner image on the image bearing member 11, a transfer member (transfer roller) 17 which forms the transfer portion (transfer nip portion) Nt in contact with the image bearing member 11 and transfers the toner image to the recording material R from the image bearing member 11 in the transfer portion Nt, the transfer power source 18 which applies the voltage to the transfer member 17, the fixing device 20 which is disposed on the downstream side of the transfer portion Nt with respect to the conveyance direction of the recording material R and forms the fixing portion (fixing nip portion) Nf for nipping the recording material R, the fixing device Nf being provided with the heating source (heater) 23 for heating the recording material R nipped by the fixing portion Nf and the heating member 21 in contact with the recording material R in the fixing portion Nf, and the heating source 23 heating the recording material R through the heating member 21 by heating by the voltage being applied from the AC power source 30, the detecting portion (current detecting portion) 13 which is connected between the image bearing member 11 and the GND without interposing the transfer member 17 and detects the current or the voltage (current in the embodiment), and the control portion 10 which controls the transfer power source 18, wherein the control portion 10 controls the current outputting from the transfer power source 18 based on the detecting result of the detecting portion 13 while the toner image is transferred to the recording material R from the image bearing member 11 in the transfer portion Nt and the recording material R is heated in the fixing portion Nf. That is, in the embodiment, the image forming apparatus 1 is connected between the image bearing member 11 and the GND in a current path from the transfer power source 18 through the transfer member 17 and the image bearing member 11 to the GND, and includes the detecting portion (current detecting portion) 13 which detects the current or the voltage (current in the embodiment). Further, in the embodiment, the image bearing member 11 is the photosensitive member. Further, in the embodiment, the detecting portion 13 detects the current which is superimposed on at least a part of the current which is output from the AC power source 30 and at least a part of the current which is output from the transfer power source 18. Further, in the embodiment, the control portion 10 controls so as to suppress the fluctuation which is described above by correcting the output current of the transfer power source 18 based on the fluctuation amplitude which is obtained from the detected result by the detecting portion 13 and the target value of the current which is supplied from the transfer power source 18 to the transfer portion Nt. Further, in the embodiment, the image forming apparatus 1 includes the environmental detecting portion (environmental sensor) 9 which detects an environment which is at least one of the temperature or humidity at least one of inside or outside the image forming apparatus 1, and the control portion 10 changes the correction amount in the correction which is described above based on the detected result by the environmental detecting portion 9. Further, in the embodiment, the image forming apparatus 1 includes the memory portion 10b which stores the index value which correlates with an amount of use of the image forming apparatus 1, and the control portion 10 changes the amount of correction in the correction which is described above based on the index value which is described above and stored in the memory portion 10b. Here, the index value which is described above is, for example, a value which is related to the cumulative number of the sheets which is printed by the image forming apparatus 1, or a value which is related to the amount of the toner which is consumed or the amount of the toner which is remained in the developing device 15. Further, the index value which is described above is a value which is related to the cumulative use of the image bearing member 11, for example.

As described above, in the embodiment, the image forming apparatus 1 includes the current detecting portion 13 which is connected between the photosensitive drum 11 and the GND in the current path which flows from the transfer power source 18 through the transfer roller 17 and the photosensitive drum 11 to the GND. And the target current value of the transfer power source 18 is varied and controlled based on the current detected result of the AC component by the current which flows from the commercial power source 30 through the recording material R to the transfer nip portion Nt, which is detected by the current detecting portion 13. Specifically, in the embodiment, the AC amplitude of the transfer nip portion Nt is suppressed by correcting the constant current target value (I_{T}) of the transfer power source 18 based on the AC banding correction value (ΔIₒᵤₜ). Therefore, according to the embodiment, it is possible to suppress the image defect such as the density unevenness (image unevenness) which is caused by the AC banding due to the current from the commercial power source 30.

Incidentally, in the embodiment, the current detecting portion 13 is described as an example, however, a means of converting from a current to a voltage or a voltage detecting means may also be used. It is sufficient to be able to detect the fluctuation of the transfer current (AC component) which is caused by the current which flows from the commercial power source 30 through the recording material R to the transfer nip portion Nt. In this case, the image forming apparatus 1 includes a voltage detecting portion as a voltage detecting means which is connected between the photosensitive drum 11 and the GND in the current path which flows from the transfer power source 18 through the transfer roller 17 and the photosensitive drum 11 to the GND. Also by this, similar to the embodiment, it is possible to obtain the same effect as in the embodiment, by controlling the transfer power source 18 so as to suppress the fluctuation of the current which flows in the current path.

### Second Embodiment

Next, another embodiment of the present invention will be described. Descriptions of a function, a configuration and an operation which are the same as or correspond to those of the image forming apparatus according to the first embodiment in the image forming apparatus in the embodiment will be omitted as appropriate.

### <Configuration of Image Forming Apparatus>

In the first embodiment, the case in which the present invention is applied to a monochrome image forming apparatus, however, the present invention is not limited to such a configuration. The present invention is also possible to apply to a configuration such as a color image forming apparatus, in which an intermediary transfer member or a primary transfer power source device is provided between the image bearing member and the transfer roller.

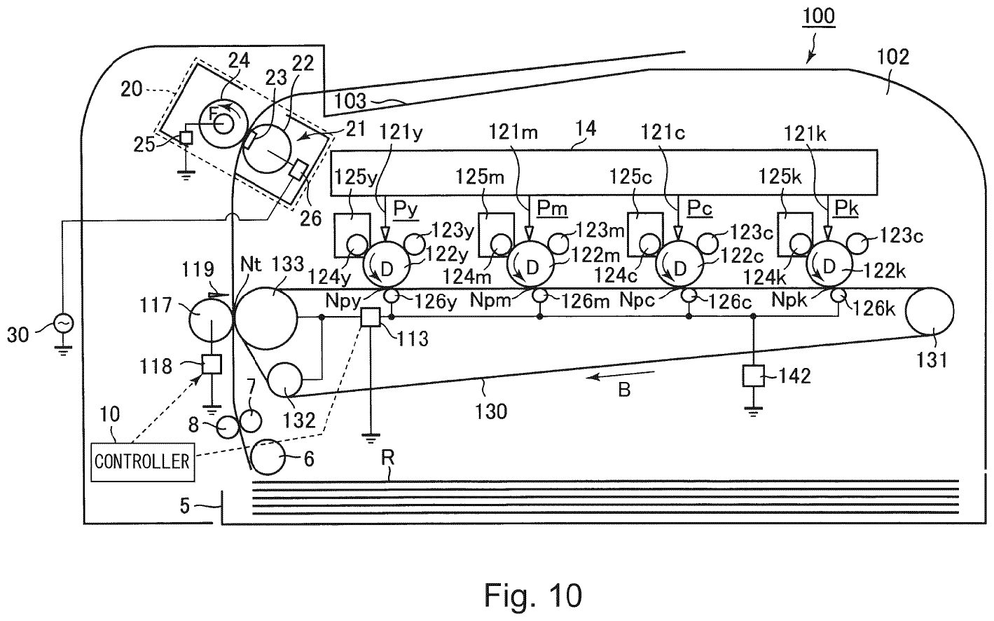

By using FIG. 10, a schematic configuration of the image forming apparatus 100 according to the embodiment will be described. FIG. 10 is a schematic sectional view of the image forming apparatus 100 according to the embodiment. The image forming apparatus 100 according to the embodiment is a tandem type laser beam printer which applies an intermediary transfer system in which it is possible to form a full color image on a sheet shaped recording material R by using an electrophotographic method.

The image forming apparatus 100 according to the embodiment includes four image forming portions (stations) Py, Pm, Pc and Pk as an image forming means which forms images of yellow, magenta, cyan and black, respectively. For elements which have same or corresponding functions or configurations which are provided for each color, the letters y, m, c or k are attached to ends of reference numerals to indicate which color it is for, however, in a case that matters which are common to each color are described, the letters of the end of the reference numerals y, m, c or k will be omitted. In the embodiment, the image forming portion P is configured of a photosensitive drum 122, a charging roller 123, the scanner unit 14, a developing device 125, etc., which will be described below. In the embodiment, the scanner unit 14 is configured as a single unit which exposes the four photosensitive drums 122y, 122m, 122c and 122k, however, it may be configured as an independent unit of each image forming portion P.

The photosensitive drum 122 as an image bearing member is rotationally driven by a drum driving motor as a driving means (unshown in the figure) at a predetermined peripheral speed (process speed) in a direction of an arrow D (counterclockwise direction) in the figure. A surface of the rotating photosensitive drum 122 is uniformly charged to a predetermined potential of a predetermined polarity (negative polarity in the embodiment) by the charging roller 123 which is a roller type charging member as a charging means. During the charging process, the charging roller 123 is charged with a charging voltage (charging bias) by a charging power source (unshown in the figure) as the charging voltage application means. The surface of the photosensitive drum 122 which is charged, is scanned and exposed by the scanner unit 14 as the exposure means (light irradiation means), and an electrostatic latent image (electrostatic image) is formed on the photosensitive drum 122. The scanner unit 14 irradiates the surface of the photosensitive drum 122 with laser light 121 according to the image signal, and forms an electrostatic latent image on the photosensitive drum 122. The electrostatic latent image which is formed on the photosensitive drum 122 is developed (visualized) when the developing device 125 as a developing means supplies toner as a developer, and the toner image is formed on the photosensitive drum 122 (on the image bearing member). The developing device 125 forms the toner image as attaching the toner to the electrostatic latent image by using the developing roller 124 as the developing member (developer bearing member). During development, the developing voltage (developing bias) is applied to the developing roller 124 by the developing power source (unshown in the figures) as a developing voltage application means. In the embodiment, the toner image is formed by the reversal development method. In the embodiment, the normal polarity of the toner, which is the main charged polarity of the toner during development, is negative.

An intermediary transfer belt 130, which is an intermediary transfer member configured of an endless belt, is arranged opposing the four photosensitive drums 122y, 122m, 122c and 122k. The intermediary transfer belt 130 is stretched over a tension roller 131, an auxiliary roller 132, and a driving roller 133 as a plurality of tension rollers, and is stretched at a predetermined tension. The intermediary transfer belt 130 rotates (peripherally moves) in a direction of an arrow B (clockwise direction) in the figure, when the driving roller 133 is driven by a belt driving motor (unshown in the figure) as a driving means, and a driving force is transmitted to the intermediary transfer belt 130. On an inner peripheral surface of the intermediary transfer belt 130, primary transfer rollers 126, which are roller type primary transfer members as a primary transfer means, are arranged corresponding to the photosensitive drum 122y, 122m, 122c and 122k respectively. The primary transfer rollers 126 press the intermediary transfer belt 130 against the photosensitive drums 122 and form primary transfer nip portions (primary transfer portions) Np, which are contact portions between the photosensitive drums 122 and the intermediary transfer belt 130. The toner image which is formed on the photosensitive drum 122 is transferred (primary transferred) onto the rotating intermediary transfer belt 130 in the primary transfer nip portion Np by an action of the primary transfer roller 126. Each of the primary transfer rollers 126y, 126m, 126c and 126k is connected to a primary transfer power source 142 as a primary transfer voltage application means, as well as the auxiliary roller 132 and the driving roller 133. During primary transferring, a primary transfer voltage (primary transfer bias), which is a DC voltage with a polarity which is opposite to a normal charging polarity of toner (positive polarity in the embodiment), is applied to the primary transfer roller 126. For example, when forming a full color image, the toner image of each color of yellow, magenta, cyan and black, which is formed on each of the photosensitive drums 122y, 122m, 122c and 122k, is sequentially transferred so that they are superimposed on the intermediary transfer belt 130.

On a side of an outer peripheral surface of the intermediary transfer belt 130, a secondary transfer roller 117 which is a roller type secondary transfer member as a secondary transfer means is arranged in a position opposing the driving roller 133, which also serves as a function of a secondary transfer opposing roller as an opposing member. The secondary transfer roller 117 is pressed against the driving roller 133, contacts the driving roller 133 via the intermediary transfer belt 130 and forms a secondary transfer nip portion (secondary transfer portion) Nt which is a contact portion between the intermediary transfer belt 130 and the secondary transfer roller 117. That is, the secondary transfer roller 117 forms the secondary transfer nip portion Nt by nipping the intermediary transfer belt 130 between the secondary transfer roller 117 and the driving roller 133. The toner image which is formed on the intermediary transfer belt 130 is transferred (secondary transferred) to the recording material R which is conveyed by being nipped between the intermediary transfer belt 130 and the secondary transfer roller 117 at the secondary transfer nip portion Nt. During secondary transferring, a secondary transfer voltage (secondary transfer bias), which is the DC voltage with the polarity which is opposite to the normal charging polarity of the toner (positive polarity in the embodiment), is applied to the secondary transfer roller 117 by a secondary transfer power source 118 as a secondary transfer voltage application means. The recording material R such as paper or OHT is accommodated in the cassette 5 as a recording material accommodating portion, and is conveyed to the secondary transfer nip portion Nt at a predetermined timing by the pickup roller 6 as the feeding member, and the conveying roller pair 7 and 8 as the conveying member.

The recording material R, to which the toner image is transferred, is conveyed to the fixing device 20 as a fixing means after a charge which is accumulated on the surface of the recording material R is electrically discharged by a charg-eliminating member 119. A configuration of the fixing device 20 of the image forming apparatus 100 according to the embodiment is substantially the same as a configuration of the fixing device 20 of the image forming apparatus 1 according to the first embodiment. That is, the fixing device 20 is configured to include the fixing film 22 which is a first fixing member (first fixing rotatable member), the heater 23 which is a heating source, and the pressing roller 24 which is a second fixing member (second fixing rotatable member). Further, the fixing device 20 is provided with the electronic part 25 and a fixing control portion 26. The heating member 21 is configured to include the fixing film 22 and the heater 23, and the pressing roller 24 forms the fixing nip portion (fixing portion) Nf by contacting the heating member 21. The heating member 21 is heated to a temperature at which it is possible to fix the toner image to the recording material R when the heater 23 generates heat by applying the AC voltage to the heater 23 from the commercial power source (AC power source) 30. The fixing device 20 heats and presses the recording material R on which the toner image is transferred by nipping and conveying between the fixing film 22 and the pressing roller 24 at the fixing nip portion Nf, and the toner image is fixed (melted, adhered) on the recording material R. After the toner image is fixed by the fixing device 20, the recording material R is discharged (output) to a discharging tray 103 as a discharging portion which is provided on an outside (top surface) of a main assembly 102 of the image forming apparatus 100.

The toner which remains on the photosensitive drum 122 after the primary transfer (primary transfer residual toner) is removed from the photosensitive drum 122 by the developing device 125, for example, and collected. Further, adhered material such as toner which remains on the intermediary transfer belt 130 after secondary transfer is removed from the intermediary transfer belt 130 and collected, for example, by a belt cleaning device (unshown in the figure). The belt cleaning device is provided on a downstream side of the secondary transfer nip portion Nt and on an upstream side of the upstreammost primary transfer nip portion Np with respect to a rotational direction of the intermediary transfer belt 130.

In the embodiment, the image forming apparatus 100 transfers the toner image from the intermediary transfer belt 130 to the recording material R by flowing a predetermined current (transfer current) from the secondary transfer power source 118 through the secondary transfer roller 117 and the secondary transfer nip portion Nt to the driving roller 133. And in the embodiment, the output current (I_{Transfer}) of the secondary transfer power source 118 and the AC current which is superimposed on the secondary transfer current via the recording material R from the commercial power source 30 flow from the driving roller 133 to the GND via the primary transfer power source 142. Therefore, in the embodiment, a current detecting portion 113, which detects the AC current which contributes to the AC banding of the secondary transfer current, is arranged between the driving roller 133 and the primary transfer power source 142. The current detecting portion 113 is connected between the driving roller 133 and the GND without interposing the secondary transfer roller 117. That is, the current detecting portion 113 is connected between the driving roller 133 and the GND in a current path from the secondary transfer power source 118 to the GND through the secondary transfer roller 117 and the driving roller 133.

Incidentally, in the embodiment, the image forming apparatus 100 includes the four image forming portions, however, the present invention is not limited to this. For example, the present invention is also possible to apply to a color image forming apparatus which sequentially forms toner images of a plurality of colors on an image bearing member (such as a photosensitive drum) of one of image forming portions and transfers the toner images to a recording material via an intermediary transfer member (such as an intermediary transfer belt).

<Method for Suppressing an Image Defect which is Caused by the AC Banding>

In the embodiment, the current detecting portion 113 is provided in a position in which the driving roller (secondary transfer opposing roller) 133 and the primary transfer rollers 126 are connected to the primary transfer power source 142. And in the embodiment, as the detecting result of the current detecting portion 113 is defined as the current amplitude (ΔI) and the output current of the secondary transfer power source 118 is defined as (I_{Transfer}), the output current of the secondary transfer power source 118 (I_{Transfer}) is controlled by a procedure in FIG. 9 which was described in the first embodiment. That is, the CPU 10a of the control portion 10 controls the Duty of the PWM signal which is sent from the transfer power source control portion 10c of the control portion 10 to the secondary transfer power source 118 so that the output current of the secondary transfer power source 118 (I_{Transfer}) becomes the transfer current target value (I_{T})

Here, the current detecting portion 113 in the embodiment is configured to detect a current by using a current detecting resistance which is connected in series between the driving roller 133 and the primary transfer power source 142. In the embodiment, the primary transfer voltage is controlled to be a constant voltage. Further, in many cases among image forming apparatuses which are provided with the intermediary transfer belt 130 such as the image forming apparatus 100 in the embodiment, there is a relationship of “a secondary transfer power source voltage is greater than a primary transfer power source voltage”. Because the recording material R is not interposed in the primary transfer nip portion Np but the recording material R is interposed in the secondary transfer nip portion Nt. Therefore, the current from the primary transfer power source 142 is returned to the GND through the primary transfer rollers 126 and the photosensitive drums 122. Further, in general the intermediary transfer belt 130 is an insulating material, it is rare to flow a current through a surface layer of the intermediary transfer belt 130. Therefore, the current from the secondary transfer nip portion Nt flows through the current detecting portion 113 and merges with the current of the primary transfer power source 142, and then returns to the GND via the primary transfer rollers 126 and the photosensitive drums 122.

Thus, even in a configuration according to the embodiment, it is possible to detect the current of the AC component which flows through the secondary transfer nip portion Nt which is necessary to suppress the AC banding by using the current detecting portion 113.

Incidentally, in the embodiment, the driving roller (opposing member) 133 and the primary transfer power source 142 are configured to be connected, however, the present invention is not limited to such a configuration. For example, the driving roller (opposing member) 133 may be configured to be independently connected to the GND and electrically grounded. In the case, it is also possible to suppress the AC banding by the similar control as described above by providing the current detecting portion 113 between the driving roller (opposing member) 133 and the GND.

Further, in the embodiment, the current detecting portion 113 is described as an example, however, as described in the first embodiment, a means of converting from a current to a voltage or a voltage detecting means may also be used. It is sufficient to be able to detect the fluctuation of the transfer current (AC component) which is caused by the current which flows from the commercial power source 30 through the recording material R to the transfer nip portion Nt. In this case, the image forming apparatus 100 includes a voltage detecting portion as a voltage detecting means which is connected between the driving roller 133 and the GND in the current path which flows from the secondary transfer power source 118 through the secondary transfer roller 117 and the driving roller 133 to the GND. Also by this, similar to the embodiment, it is possible to obtain the same effect as in the embodiment, by controlling the secondary transfer power source 118 so as to suppress the fluctuation of the current which flows in the current path.

As described above, in the embodiment, the image forming apparatus 100 is provided with the image bearing member (photosensitive drum) 11 which bears the toner image, the developing device 15 which supplies the toner to the image bearing member 11 and forms the toner image on the image bearing member 11, the intermediary transfer member (intermediary transfer belt) 130 to which the toner image is transferred from the image bearing member 11 and capable of circularly moving, an opposing member (driving roller) 133 in contact with the inner circumferential surface of the intermediary transfer member 130, a transfer member (secondary transfer roller) 117 in contact with an outer circumferential surface of the intermediary transfer member 130, configured to form the transfer portion (secondary transfer nip portion) Nt by nipping the intermediary transfer member 130 between itself and the opposing member 133, and configured to transfer the toner image to the recording material R from the intermediary transfer member 130 in the transfer portion Nt, the transfer power source (secondary transfer power source) 118 configured to apply a voltage to the transfer member 117, the fixing device 20 disposed on a downstream side of the transfer portion Nt with respect to a conveyance direction of the recording material R and configured to form the fixing portion (fixing nip portion) Nf for nipping the recording material R, the fixing device 20 being provided with the heating source 23 for heating the recording material R nipped by the fixing portion Nf and the heating member 21 in contact with the recording material R in the fixing portion Nf and the heating source 23 heating the recording material R through the heating member 21 by heating by the voltage being applied from the AC power source 30, the detecting portion (current detecting portion) 113 connected between the opposing member 133 and the GND without interposing the transfer member 117 and configured to detect a current or a voltage (current in the embodiment) and the control portion 10 configured to control the transfer power source 118, wherein the control portion 10 controls the current outputting from the transfer power source 118 based on a detecting result of the detecting portion 113 while the toner image is transferred to the recording material R from the intermediary transfer member 130 in the transfer portion Nt and the recording material R is heated in the fixing portion Nf. That is, in the embodiment, the image forming apparatus 100 is connected between the opposing member 133 and the GND in a current path from the transfer power source 118 through the transfer member 117 and the opposing member 133 to the GND, and includes the detecting portion (current detecting portion) 113 which detects the current or the voltage (current in the embodiment). Further, in the embodiment, the intermediary transfer member 130 is an intermediary transfer belt which is configured of an endless belt.

As described above, according to the embodiment, it is possible to suppress an image defect which is caused by a current from a commercial power source even in a color image forming apparatus, similar to the monochrome image forming apparatus according to the first embodiment.

### [Others]

As described above, the present invention is described in accordance with specific embodiments, however, the present invention is not limited to the embodiments which are described above.

For example, the information which is described as being input from the external device in the embodiments which are described above may be input from an operation portion with which the image forming apparatus is provided.

Further, the control to suppress the AC banding which is described in the embodiments which are described above may be executed only in a case that a predetermined condition is met, such as in a case that the current amplitude (ΔI) which is detected by the current detecting portion exceeds a predetermined threshold value, for example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-015296 filed on Feb. 2, 2024, which is hereby incorporated by reference herein in its entirety.

What is claimed is:

1. An image forming apparatus comprising:
an image bearing member configured to bear a toner image;
a developing device configured to supply toner to the image bearing member and form the toner image on the image bearing member;
a transfer member configured to form a transfer portion in contact with the image bearing member and to transfer the toner image to a recording material from the image bearing member in the transfer portion;
a transfer power source configured to apply a voltage to the transfer member;
a fixing device disposed on a downstream side of the transfer portion with respect to a conveyance direction of the recording material and configured to form a fixing portion for nipping the recording material, the fixing device being provided with a heating source for heating the recording material nipped by the fixing portion and a heating member in contact with the recording material in the fixing portion and the heating source heating the recording material through the heating member by heating by the voltage being applied from an AC power source;
a detecting portion connected between the image bearing member and a ground potential without interposing the transfer member and configured to detect a current or a voltage; and
a control portion configured to control the transfer power source,
wherein the control portion controls the current output from the transfer power source based on a detecting result of the detecting portion while the toner image is transferred to the recording material from the image bearing member in the transfer portion and the recording material is heated in the fixing portion.

2. The image forming apparatus according to claim 1, wherein the image bearing member is a photosensitive member.

3. The image forming apparatus according to claim 1, wherein the detecting portion detects a current on which at least a part of the current output from the AC power source and at lease a part of the current output from the transfer power source are superposed.

4. The image forming apparatus according to claim 1, wherein based on an amplitude of a fluctuation acquired from the detecting result of the detecting portion and a target value of a current supplied from the transfer power source to the transfer portion, the control portion performs a correction of an output current from the transfer power source and controls so as to suppress the fluctuation.

5. The image forming apparatus according to claim 4, further comprising an environment detecting portion configured to detect an environment which is at least one of a temperature and a humidity of at least one of an inside and an outside of the image forming apparatus,
wherein based on a detecting result of the environment detecting portion, the control portion changes a correcting amount in the correction.

6. The image forming apparatus according to claim 4, further comprising a memory portion configured to memorize an index value correlating with a usage amount of the image forming apparatus,
wherein based on the index value memorized in the memory portion, the control portion changes a correcting amount in the correction.

7. The image forming apparatus according to claim 6, wherein the index value is a value relating with a number of accumulated printed sheet by the image forming apparatus or a value relating with a toner consumption amount or a toner remaining amount of the image forming apparatus.

8. The image forming apparatus according to claim 6, wherein the index value is a value relating with an accumulated usage amount of the image bearing member.

9. An image forming apparatus comprising:
an image bearing member configured to bear a toner image;
a developing device configured to supply toner to the image bearing member and form the toner image on the image bearing member;
an intermediary transfer member to which the toner image is transferred from the image bearing member and capable of circularly moving;
an opposing member in contact with an inner circumferential surface of the intermediary transfer member;
a transfer member in contact with an outer circumferential surface of the intermediary transfer member, configured to form a transfer portion by nipping the intermediary transfer member between itself and the opposing member, and configured to transfer the toner image to a recording material from the intermediary transfer member in the transfer portion;
a transfer power source configured to apply a voltage to the transfer member;
a fixing device disposed on a downstream side of the transfer portion with respect to a conveyance direction of the recording material and configured to form a fixing portion for nipping the recording material, the fixing device being provided with a heating source for heating the recording material nipped by the fixing portion and a heating member in contact with the recording material in the fixing portion and the heating source heating the recording material through the heating member by heating by the voltage being applied from an AC power source;
a detecting portion connected between the opposing member and a ground potential without interposing the transfer member and configured to detect a current or a voltage; and
a control portion configured to control the transfer power source,
wherein the control portion controls the current outputting from the transfer power source based on a detecting result of the detecting portion while the toner image is transferred to the recording material from the intermediary transfer member in the transfer portion and the recording material is heated in the fixing portion.

10. The image forming apparatus according to claim 9, wherein the intermediary transfer member is an intermediary transfer belt constituted by an endless belt.

11. An image forming apparatus comprising:
an image bearing member configured to bear a toner image;
a developing device configured to supply toner to the image bearing member and form the toner image on the image bearing member;
a transfer member configured to form a transfer portion in contact with the image bearing member and to transfer the toner image to a recording material from the image bearing member in the transfer portion;
a transfer power source configured to apply a voltage to the transfer member;
a fixing device disposed on a downstream side of the transfer portion with respect to a conveyance direction of the recording material and configured to form a fixing portion for nipping the recording material, the fixing device being provided with a heating source for heating the recording material nipped by the fixing portion and a heating member in contact with the recording material in the fixing portion and the heating source heating the recording material through the heating member by heating by the voltage being applied from an AC power source;
a detecting portion connected between the image bearing member and a ground potential in a current path from the transfer power source to the ground potential through the transfer member and the image bearing member, and configured to detect a current or a voltage; and
a control portion configured to control the transfer power source,
wherein the control portion controls the current outputting from the transfer power source based on a detecting result of the detecting portion while the toner image is transferred to the recording material from the image bearing member in the transfer portion and the recording material is heated in the fixing portion.
